(19) United States
(12) Patent Application Publication
(10) Pub. No.: US 2014/0164939 A1
(43) Pub. Date: Jun. 12, 2014

(54) INFORMATION PROCESSING APPARATUS AND METHOD AND STORAGE MEDIUM

(71) Applicant: CANON KABUSHIKI KAISHA, Tokyo (JP)

(72) Inventor: Makiya Tamura, Tokyo (JP)

(73) Assignee: CANON KABUSHIKI KAISHA, Tokyo (JP)

(21) Appl. No.: 14/070,152

(22) Filed: Nov. 1, 2013

(30) Foreign Application Priority Data
Dec. 11, 2012 (JP) 2012-270525

(51) Int. Cl. H04L 12/24

(52) U.S. Cl. CPC H04L 41/0246
USPC 715/740

(57) ABSTRACT

In a case where a user needs to perform an operation on a web browser in order to operate an application, the user has to switch between the application and the web browser. The present invention enables an information processing apparatus to perform screen switching from the application to the web browser and from the web browser to the application.

### BACKGROUND OF THE INVENTION

1. Field of the Invention

The present invention relates to an information processing apparatus, and a method and a storage medium. Particularly, the present invention relates to control of operation screens for cooperative operations of an application and a web browser running in the information processing apparatus.

2. Description of the Related Art

Recently, in an image processing apparatus, an execution environment (for example, Java (registered trademark) or the like) for an embedded system different from a real-time operating system (hereafter, abbreviated as real-time OS) has been built on the real-time OS. With this configuration, an application for controlling the image processing apparatus can be installed and loaded in the image processing apparatus from the outside.

Moreover, along with enhancement in performances and increase in the number of functions of image processing apparatuses, image processing apparatuses with various scan functions and print functions have been developed. Recently, there has been developed an image processing apparatus equipped with a network interface (hereafter, abbreviated as I/F), in addition to basic functions such as the scan function and the print function which include digitization and printing of paper documents. The image processing apparatus equipped with the network I/F provides various solutions by cooperating with external systems and external services connected via a network.

In one use case, the image processing apparatus cooperates with a first external service and the first external service cooperates with a second external service having a different security domain. This use case is one seen in a case where a cloud service and another cloud service cooperate with each other, the cloud services provided by cloud computing systems recently having been put to practical use.

In the aforementioned use case, for example, there is a case where image data obtained by reading an original document is transmitted from the image processing apparatus to the first external service and the image data is further transmitted from the first external service to the second external service with security being ensured. In this case, a system called OAuth is generally used. OAuth follows open specifications for “authority information delegation” in which a right of a user is securely passed between services having a trust relationship established in advance, with the consent of the user.

In a case of using the system of OAuth, the first external service needs to receive authorization information from the second external service. In this case, an operation on a web browser by the user is virtually essential for the first external service to receive the authorization information from the second external service. This operation will be specifically described below.

The following processes are performed in a case where original document reading is executed by an application on the image processing apparatus, obtained image data is processed in the first external service, and the processed data is transmitted to the second external service.

First, the user selects the application on the image processing apparatus from a top menu of an operation screen of the image processing apparatus and gives an instruction of original document reading. The image processing apparatus executes original document reading according to the instruction from the user and transmits the obtained image data to the first external service. The first external service processes the received image data through OCR or conversion to PDF file, and transmits the processed image data to the second external service which performs file management. Here, the transmission process of the image data from the first external service to the second external service fails in a case where the first external service has not received the authorization information of the second external service or in a case where the authorization information is invalid.

The following processes are performed in the case where the transmission process of the image data from the first external service to the second external service fails. The user returns to the top menu of the operation screen of the image processing apparatus from the operation screen of the application which is displayed on the operation screen of the image processing apparatus. Then, the user newly selects the web browser and accesses a page for the first external service to obtain the authorization information of the second external service by using the web browser. Thereafter, the user performs an authorization information obtaining operation according to instructions on a screen displayed on the web browser and information is thereby exchanged between the first external service and the second external service according to the system of OAuth. The authorization information of the second external service is thus stored in the first external service.

After completing the authorization information obtaining operation, the user returns to the top menu of the operation screen of the image processing apparatus, selects the application, and gives the instruction of executing the scan process. The image processing apparatus executes the scan process according to the instruction from the user and transmits obtained image data to the first external service again. The first external service processes the received image data through OCR or conversion to PDF file again and transmits the processed image data to the second external service again.

As described above, the screen switching frequently occurs on the operation screen of the image processing apparatus and the user operations are cumbersome. To address such problems, Japanese Patent Laid-Open No. 2007-279974 provides an apparatus which performs screen display in one application, by determining a next screen to be displayed on the basis of screen transition information defined for each user, and generating screen data based on the result of the determination.

Since the application and the web browser are separate applications in the software configuration of the image processing apparatus, the authentication operation to the first external service requires the authorization operation on the web browser. Moreover, due to restrictions of the operation screen of the image processing apparatus, only one application can be displayed on the screen at a time. Furthermore, applications of the image processing apparatus are managed in a uniform manner, and therefore an individual application cannot perform screen switching from the application to the web browser and from the web browser to the application on its own initiative.

Accordingly, the user operations on the image processing apparatus are cumbersome. For example, in the aforementioned use case, the user needs to perform an operation for scan process execution twice. Moreover, the operation for receiving the authorization cannot be performed as a part of a series of screen operations on the image processing apparatus.

### SUMMARY OF THE INVENTION

An information processing apparatus of one aspect of the present invention includes: a display unit configured to display an operation screen of an application including a process of instructing a first server to perform a process on a second server; a first screen control unit configured to display a browser on the display unit in a case where authorization information used in the process to be performed by the first server on the second server is invalid, the browser configured to perform an operation of validating the authorization information; and a second screen control unit configured to display the operation screen of the application on the display unit in a case where the operation of validating the authorization information is completed.

In the present invention, it is possible to call a web browser from an arbitrary application on the image processing apparatus on the basis of a result of determination on whether the authorization information of a user is valid or invalid in a data transmission target. Moreover, screen control can be returned to the application which is a calling source, after an operation on the web browser is completed.

Further features of the present invention will become apparent from the following description of exemplary embodiments (with reference to the attached drawings).

### BRIEF DESCRIPTION OF THE DRAWINGS

FIG. 1 is an overall diagram of a system example in a first embodiment of the present invention;

FIG. 2 is a block diagram showing a configuration example of an image processing apparatus 100 in the first embodiment of the present invention;

FIG. 3 is a block diagram showing a configuration example of an external server A120 in the first embodiment of the present invention.

FIG. 4 is a diagram showing a software configuration example of the image processing apparatus 100 in the first embodiment of the present invention;

FIG. 5 is a block diagram showing a configuration example of an application 408 in the first embodiment of the present invention;

FIG. 6 is a block diagram showing a configuration example of a web browser 403 in the first embodiment of the present invention;

FIG. 7 is a view showing an example of an operation screen of the application 408 in the first embodiment of the present invention;

FIG. 8 is a diagram showing the relationship of FIGS. 8A and 8B;

FIGS. 8A and 8B are a view showing an example of a process sequence in the first embodiment of the present invention;

FIG. 9 is a view showing an example of a flowchart of the application 408 in the first embodiment of the present invention;

FIG. 10 is a view showing an example of a flowchart of the web browser 403 in the first embodiment of the present invention;

FIG. 11 is a diagram showing the relationship of FIGS. 11A and 11B;

FIGS. 11A and 11B are a diagram showing an example of a process sequence in a second embodiment of the present invention;

FIG. 12 is a view showing an example of a flowchart of an application 408 in the second embodiment of the present invention and

FIG. 13 is a view showing an example of a flowchart of a web browser 403 in the second embodiment of the present invention.

### DESCRIPTION OF THE EMBODIMENTS

Embodiments of the present invention are described below by using the drawings. Note that the embodiments described below do not limit the invention of the claims and not all of the combinations of the characteristics described in the embodiments are necessary for solving method of the invention.

### First Embodiment

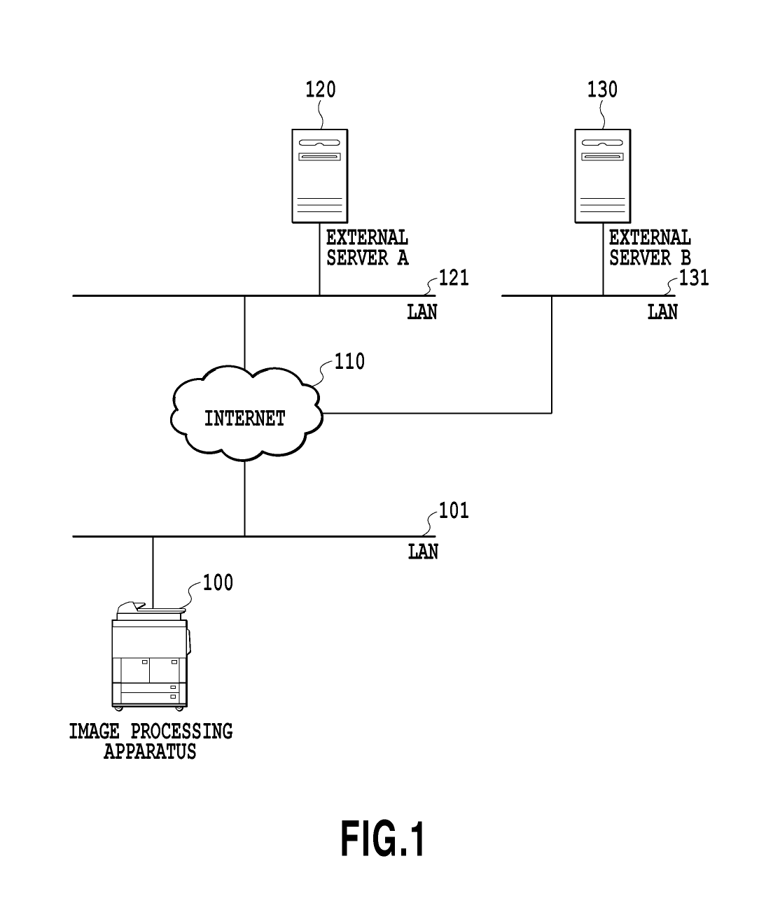

FIG. 1 is a diagram showing an example of an entire image processing system in the embodiment of the present invention. An image processing apparatus 100 is connected to the Internet 110 via a LAN 101. Moreover, an external server A120 is connected to the Internet 110 via a LAN 121. The image processing apparatus 100 can communicate with the external server A120 and use functions provided by the external server A120 via these networks. Furthermore, an external server B130 is connected to the Internet 110 via a LAN 131. The external server A120 can communicate with the external server B130 and use functions provided by the external server B130 via these networks.

Here, assume that the external server A120 and the external server B130 are servers which operate in authentication domains different from each other. Accordingly, in the embodiment, the external server A120 and the external server B130 are connected to each other via the Internet for the sake of description. However, the external server A120 and the external server B130 may be connected via a LAN as long as the authentication domains thereof are different.

Moreover, the external server A120 and the external server B130 may be servers providing services in a cloud computing environment. In the embodiment, an example is given of a case where the single external server A120 provides an image processing service. However, as another mode, the external server A120 may be formed of multiple servers and perform distributed processing by activating multiple virtual machines in the multiple servers. In this case, a technique (cloud computing) called scale out is used in which the number of the virtual machines is increased according to a predetermined condition. This is the same for the external server B130. In the embodiment, an example is given of a case where the single external server B130 provides a file managing service. However, as another mode, the external server B130 may be formed of multiple servers and perform distributed processing by activating multiple virtual machines in the multiple servers.

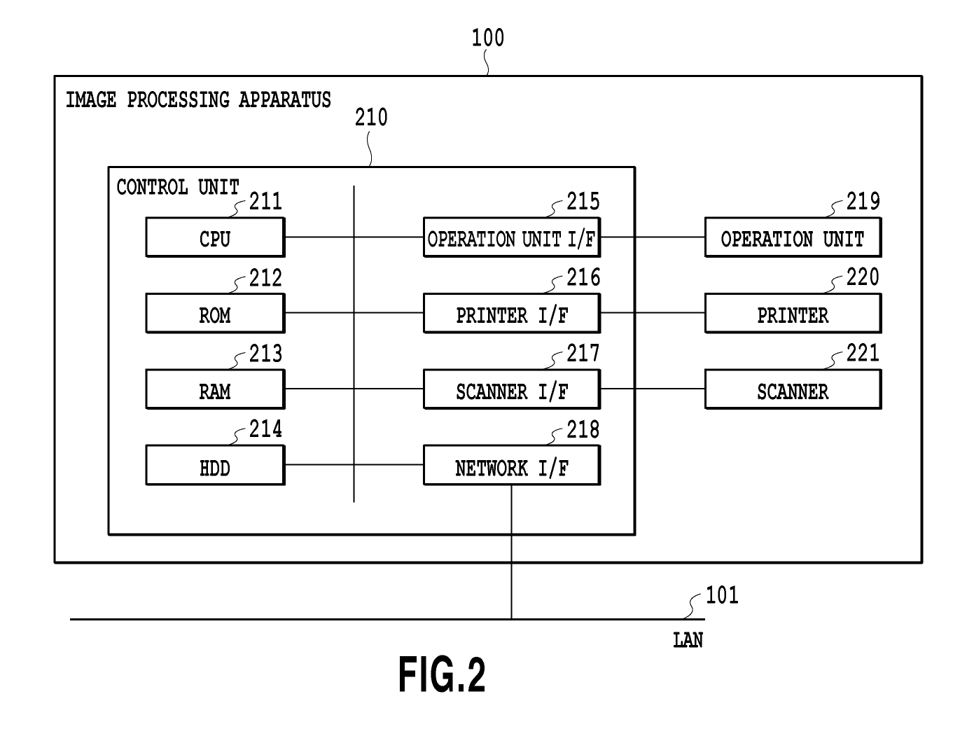

FIG. 2 is a block diagram showing a configuration of the image processing apparatus 100 in the first embodiment. A control unit 210 including a CPU 211 controls operations of the entire image processing apparatus 100. The CPU 211 reads a control program stored in ROM 212 and performs various types of control such as read control and transmission control. A controller control unit 401 to be described later is implemented by the control program. RAM 213 is used as main memory of the CPU 211 and a temporary storage area such as a work area.

A HDD 214 stores various programs and image data or various information tables. An operation unit I/F 215 connects an operation unit 219 and the control unit 210 to each other. The operation unit 219 includes a keyboard, a liquid-crystal display unit having a touch panel function, and the like. A web browser 403 and an application 408 of the image processing apparatus 100 which will be described later display operation screens on the liquid-crystal display unit of the operation unit 219 by calling an API 402 and a virtual machine API 405 which will be described later, according to a process, and requesting the controller control unit 401 to perform a process.

A printer I/F 216 connects a printer 220 and the control unit 210 to each other. Image data to be printed by the printer 220 is transferred from the control unit 210 via the printer I/F 216 and is printed on a recording medium in the printer 220. The web browser 403 and the application 408 of the image processing apparatus 100 which will be described later execute a print process by calling the API 402 and the virtual machine API 405 which will be described later, according to a process, and requesting the controller control unit 401 to perform a process.

A scanner I/F 217 connects a scanner 221 and the control unit 210 to each other. The scanner 221 generates image data by reading an image on an original document and inputs the image data into the control unit 210 via the scanner I/F 217. The web browser 403 and the application 408 of the image processing apparatus 100 which will be described later execute a scan process and receive the image data by calling the API 402 and the virtual machine API 405 which will be described later, according to a process, and requesting the controller control unit 401 to perform a process.

A network I/F 218 connects the control unit 210 (image processing apparatus 100) and the LAN 101 to each other. The network I/F 218 transmits image data and information to an external apparatus on the LAN 101 and receives various types of information from the external apparatus on the LAN 101.

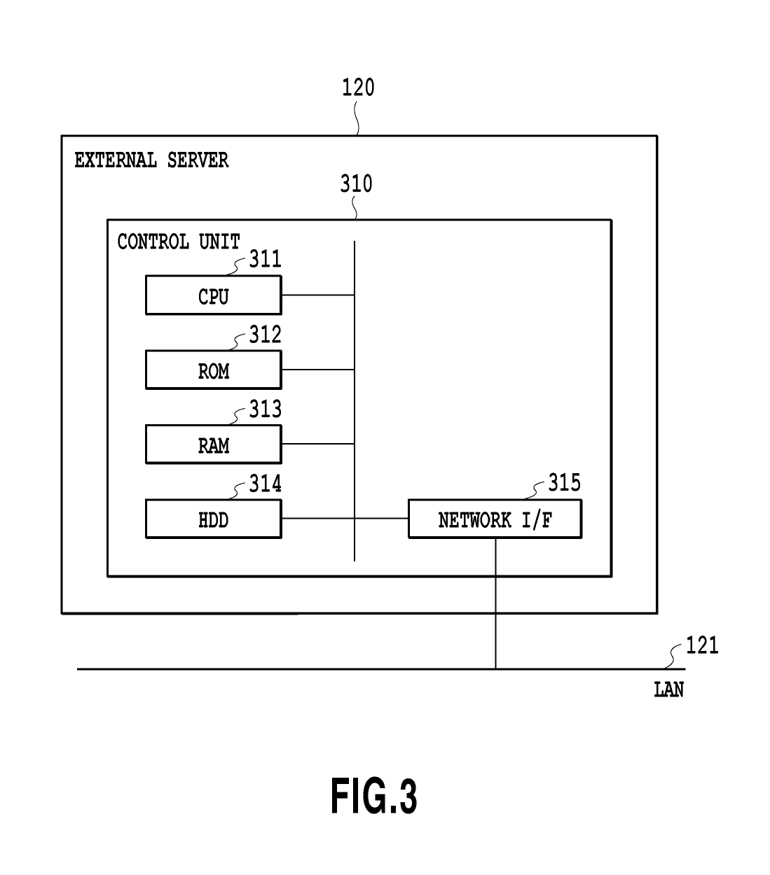

FIG. 3 is a block diagram showing an example of a configuration of the external server A120 which provides an external service in the first embodiment. A control unit 310 including a CPU 311 controls operations of the external server A120. The CPU 311 reads a control program stored in ROM 312 and executes various types of control processes. RAM 313 is used as main memory of the CPU 311 and a temporary storage area such as a work area. A HDD 314 stores various programs and image data or various information tables to be described later.

A network I/F 315 connects the control unit 310 (external server A120) and the LAN 121 to each other. The network I/F 315 transmits and receives various types of information to and from another apparatus on the LAN 121.

The external server B130 can have the same configuration as the external server A120.

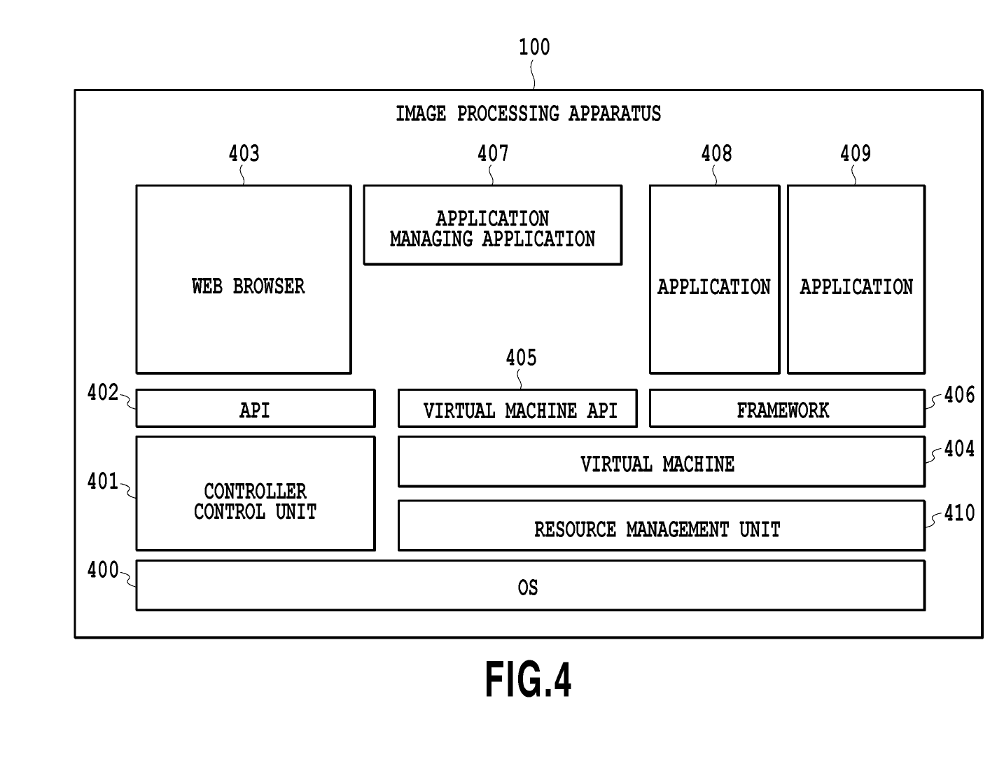

FIG. 4 is a diagram showing an example of a basic software configuration of the image processing apparatus 100 in the first embodiment. An operating system (hereafter, abbreviated as OS) 400 is an example of a first execution environment in the first embodiment for controlling the entire image processing apparatus 100. Generally, the OS 400 is formed of modules of a real-time OS capable of controlling various functions of the image processing apparatus 100 in real-time or libraries capable of critically controlling various functions including an expansion card and optional devices of a copier by giving commands to the CPU. Furthermore, the OS 400 includes modules which provide interface commands to applications running on top of the OS 400.

The controller control unit 401 runs on the OS 400 and is formed of modules configured to control the aforementioned scanner 221, the aforementioned printer 220, and the like.

The application programming interface (hereafter, abbreviated as API) 402 has a function of accessing the controller control unit 401 in response to a string of commands inputted from applications. Moreover, the API 402 has a function of sending control commands to devices and the like connected to the network, via the network I/F 218.

The web browser 403 is one of applications which run on the OS 400. The web browser 403 uses the API 402 and requests the controller control unit 401 to perform various types of processes.

A virtual machine 404 is a second execution environment optimal for executing specific applications and is implemented by, for example, a virtual machine of Java (registered trademark) or the like.

The virtual machine API 405 is an API used by the applications on the virtual machine 404 to access the controller control unit 401 running on the OS 400, and in the embodiment, has a function of a conversion module used to call the API 402. In the embodiment, description is given under the assumption that the applications 408, 409 are applications to be executed on the virtual machine 404. However, the applications to be executed on the virtual machine 404 may include applications such as the web browser 403.

A framework module 406 has a function of integrally controlling the applications on the virtual machine 404. An application managing application 407 is an application for managing other applications on the virtual machine 404. The application managing application 407 performs download, upload, deletion, and disabling of the applications 408, 409, together with the framework 406.

The applications 408, 409 are applications which run on the virtual machine 404, and request the controller control unit 401 to perform various types of processes by using the virtual machine API 405.

A resource management unit 410 is a resource managing unit which manages resources used by the virtual machine 404, and runs on the OS 400. The resource management unit 410 imposes predetermined limitation on use of resources, such as a memory, by the virtual machine 404, the virtual machine API 405, the framework 406, or all of the applications on the OS 400. For example, UI display cannot be performed in a case where the number of applications whose screens are displayed on the operation unit 219 exceeds a predetermined application upper limit number.

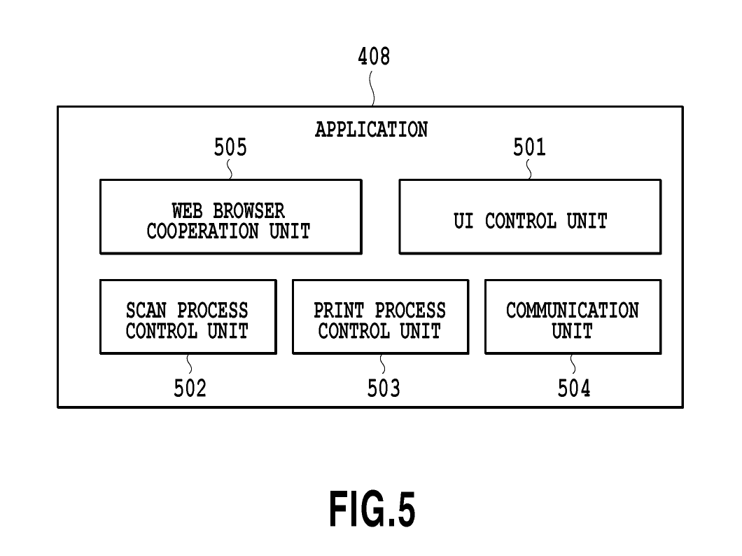

FIG. 5 is a block diagram showing a configuration of the application 408.

A UI control unit 501 displays an UI to prompt a user to perform setting required for the image processing apparatus to perform processes. For example, in a case where the scan process is to be performed, the UI control unit 501 displays an UI for setting scan data which can be generated by the image processing apparatus. Moreover, in a case where the print process is to be performed, the UI control unit 501 displays an UI for setting obtainment of data which can be printed by the image processing apparatus. Furthermore, the UI control unit 501 performs control of displaying the screen of the application 408 on a front face of the operation unit 219 in response to a request from a web browser cooperation unit 505 to be described later.

According to contents of the setting in the UI control unit 501, a scan process control unit 502 performs a process, in consideration of whether the contents of the setting match the processing capacity of the image processing apparatus.

According to contents of the setting in the UI control unit 501, a print process control unit 503 performs a process in consideration of whether the contents of the setting match the processing capacity of the image processing apparatus.

A communication unit 504 communicates with the external server A120 and the external server B130, thereby performs data transmission and reception, and performs file transmission and reception according to FTP, SMB, WebDAV, and the like.

The web browser cooperation unit 505 communicates with the web browser 403 and performs processes of calling the web browser 403 and receiving a notification of operation completion from the web browser 403. Upon receiving the notification of operation completion from the web browser 403, the web browser cooperation unit 505 requests the UI control unit 501 to display the screen of the application 408 on the front face of the operation unit 219.

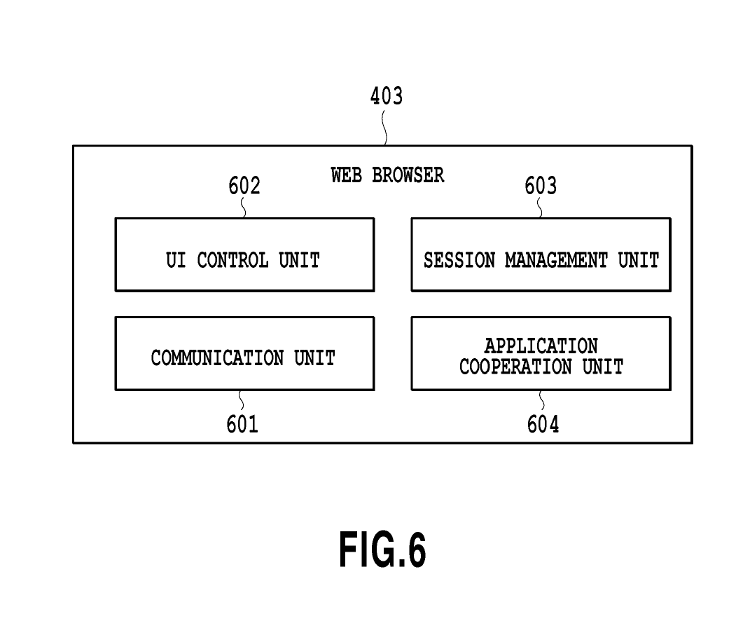

FIG. 6 is a block diagram showing a configuration of the web browser 403.

A communication unit 601 communicates with the external server A120 and the external server B130 according to, for example, HTTP protocol/HTTPS protocol. Moreover, the communication unit 601 can communicate with the communication unit 504 of an application in the image processing apparatus such as the application 408. To be more specific, the communication unit 601 transmits information inputted through the operation screen displayed by a UI control unit 602 of the web browser 403, as a request to an application in the external server A120 and the like. Moreover, the communication unit 601 receives responses (processing results) transmitted from the application in the external server A120 and the like.

The UI control unit 602 analyzes HTML files included in the responses received by the communication unit 601 and displays the operation screen on the operation unit 219 on the basis of analysis results. Moreover, the UI control unit 602 performs control of displaying the screen of the web browser 403 on the front face of the operation unit 219, in response to a request from an application cooperation unit 604 to be described later.

A session management unit 603 manages session information used in communication between the external server A120 and the web browser 403.

The application cooperation unit 604 communicates with the application 408, and thereby performs processes of receiving a call request for the web browser 403 from the application 408 and transmitting the notification of operation completion to the application 408. Upon receiving the call request for the web browser 403 from the application 408, the application cooperation unit 604 requests the UI control unit 602 to display the screen of the web browser 403 on the front face of the operation unit 219.

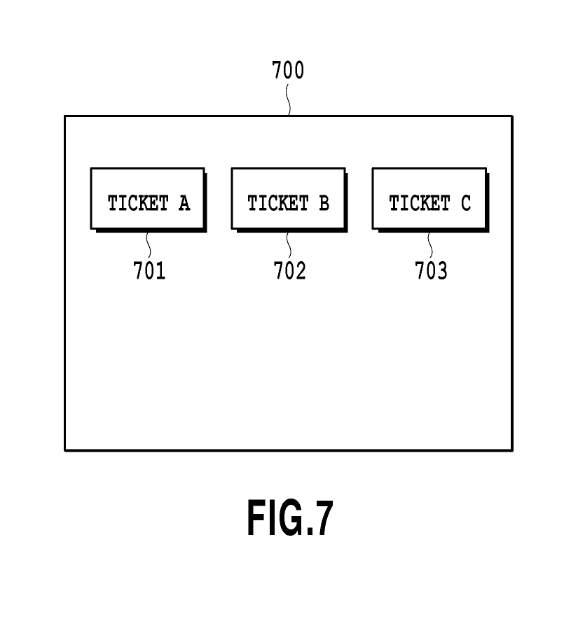

FIG. 7 is a view showing an example of the operation screen of the application 408 in the first embodiment. As described above, in the embodiment, the external server A120 provides the image processing service while the external server B130 provides the file management service. In the image processing service, the external server A120 receives an image file from the image processing apparatus 100, performs a designated image process on the received image file, and transmits the resultant image file to the external server B130. Here, settings of parameters and the like related to the image process performed in the external server A120, information on a transmission target other than the authentication information which is used in the transmission to the external server B130, and the like are managed as, for example, tickets. For example, in a case where the image processing apparatus 100 transmits the image file obtained in the scanning to the external server A120, the image processing apparatus 100 inquires of the external server A120 what types of tickets exist in advance, and transmits the image file to the external server A120 by designating a ticket according to an instruction of the user.

A screen 700 is a display example in a case where the image processing apparatus 100 has made in advance an inquiry to the external server A120 on what type of ticket exists, and tickets which are inquiry results are displayed on the operation unit 219 as buttons. In this example, tickets 701, 702, 703 are displayed. The user pressing one of the buttons corresponding to the tickets causes the image processing apparatus 100 to execute scanning and send image data obtained as a result of scanning to the external server A120 as an image file, together with ticket information corresponding to the pressed button.

Here, the external server A120 executes the image process on the image file transmitted from the image processing apparatus 100, according to the ticket, and transmits the resultant image file to the external server B130. In the transmission of the image file from the external server A120 to the external server B130, the external server A120 accesses the external server B130 by using an authorization token obtained in a system of OAuth to be described later.

The embodiment is described by giving an example in which combinations of various types of information are managed as tickets and one of the tickets is designated to set parameters and the like which are related to the image process performed by the external server A120 and to set the transmission target information and the like. However, there may be employed a mode in which the user appropriately designates the various types of information as necessary without using the ticket and thereby sets the various types of information.

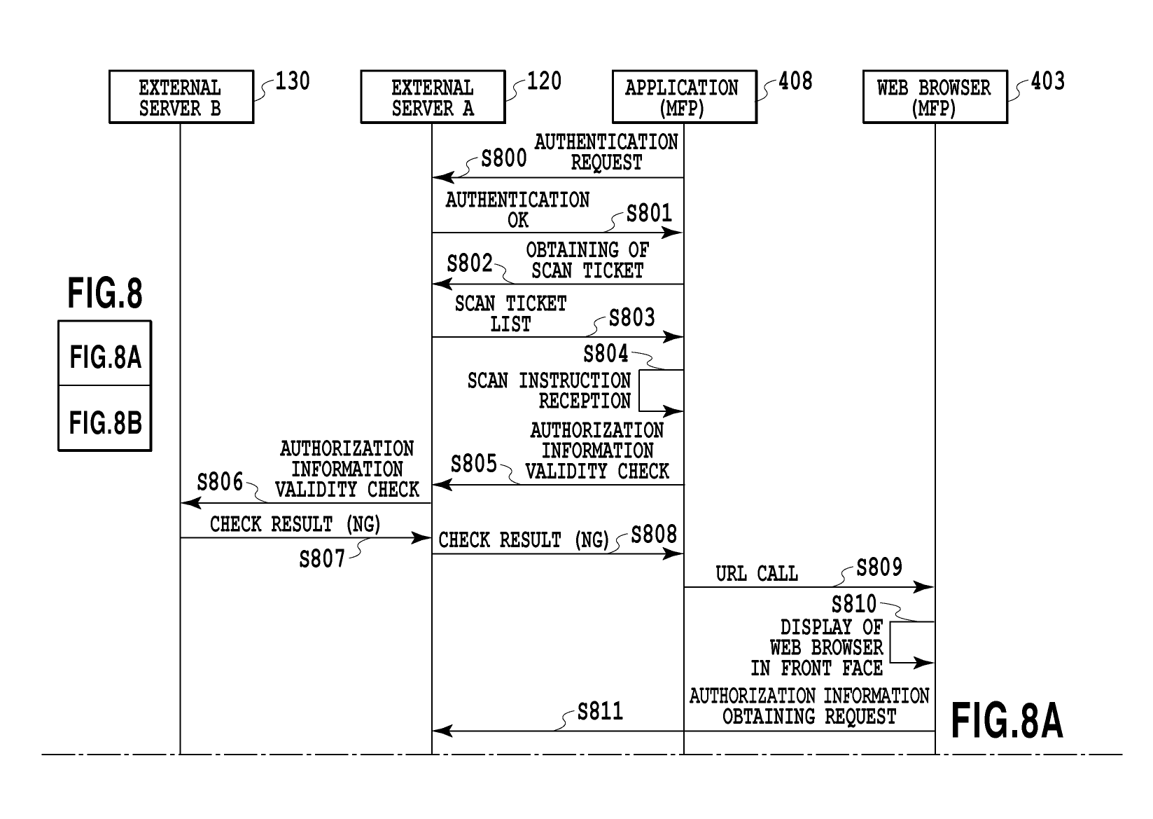

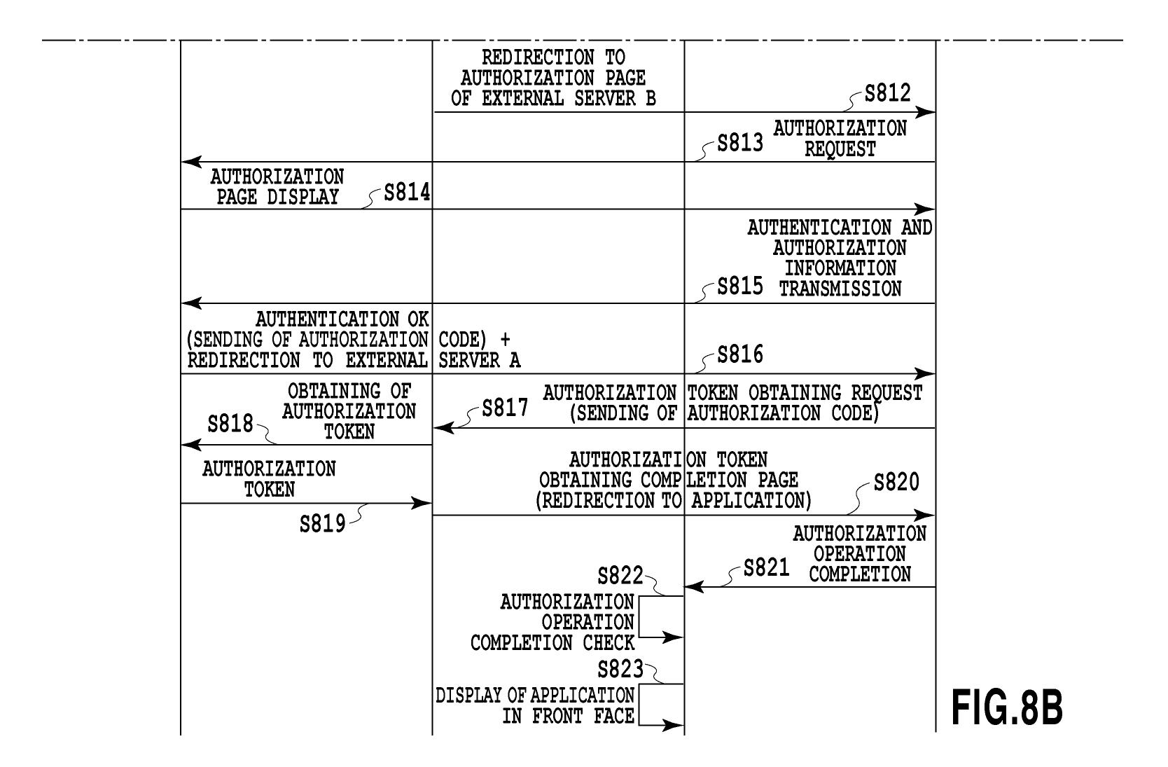

FIG. 8 is a view showing an example of a process sequence in the embodiment.

In step S800, the application 408 transmits an authentication request to the external server A120. The authentication request is a request that the external server A120 should authenticate the user of the application 408 in order to enable the application 408 to access the external server A120. The application 408 displays a screen for inputting information such as a user ID and a password which is required for the authentication to the external server A120, on the operation unit 219. The application 408 includes, into the authentication request to the external server A120, the information such as the user ID and the password which is inputted by an operation of the user through the screen and which is required for the authentication, and transmits the authentication request.

In step S801, the external server A120 performs an authentication process by using the information such as the user ID and the password which is included in the authentication request transmitted from the application 408, and sends a reply on whether the authentication has succeeded or failed. Here, a case where the authentication is successful is shown.

In step S802, the application 408 sends the external server A120 a request for obtaining the ticket information managed by the external server A120.

In step S803, the external server A120 sends back a list of the ticket information managed by the external server A120, according to the request from the application 408. The ticket information includes a ticket name, image process information, transmission target information, and the like.

In step S804, the application 408 displays an operation screen like one shown in FIG. 7, on the basis of the ticket information obtained in step S803. Upon pressing one of the tickets 701, 702, 703 by the user, the application 408 determines that an application execution instruction has been given. In the embodiment, the application 408 determines that a scan instruction has been given.

In step S805, the application 408 inquires of the external server A120 whether the authorization token managed by the external server is present or absent or whether the authorization token is valid or invalid. Specifically, the application 408 inquires of the external server A120 whether the authorization token between the external server A120 and a transmission target (external server B130 in the example) shown by the transmission target information included in the pressed ticket is present or absent or whether the authorization token is valid or invalid.

In step S806, according to the inquiry from the application 408, the external server A120 checks whether the external server A120 holds the authorization token for the transmission target specified by the ticket information included in the inquiry from the application 408. In a case where the external server A120 holds the authorization token, the external server A120 further checks whether the authorization token held by the external server A120 is valid for the external server B130 which is the transmission target specified by the ticket information.

In step S807, the external server B130 determines whether the authorization token held by the external server A120 is valid or invalid, according to an inquiry from the external server A120. The external server B130 sends back a determination result to the external server A120. FIG. 8 shows a case where the authorization token is invalid.

In step S808, the external server A120 sends a reply to the application 408 on the basis of the check result of presence or absence of the authorization token in the external server A120 in step S806 or the result sent back from the external server B130. FIG. 8 shows a case where the authorization token is not held by the external server A120 or a case where the authorization token is invalid.

In the case where the authorization token is invalid in the result sent back in step S808, the application 408 needs the external server A120 to obtain a valid authorization token. In step S809, the application 408 calls the web browser 403 in order for the external server A120 to obtain the valid authorization token. In this step, the application 408 passes information required to obtain the authorization token to the web browser 403. The information required herein includes URL information which is address information for accessing the external server A120 and session information of communication currently performed with the external server A120.

In step S810, the web browser 403 displays the web browser 403 itself on the front face of the operation unit 219, according to the call from the application 408 (first screen control process).

In step S811, the web browser 403 transmits a HTTP request on the basis of the URL information for accessing the external server A120 which is obtained from the application 408. In this step, the web browser 403 uses the session information received from the application 408. The web browser 403 thereby takes over the session in which the application 408 and the external server A120 communicate with each other, upon accessing the external server A120. Accordingly, it is possible to omit a work of the user inputting the information for the authentication in accessing the external server A120 from the web browser 403. Although the example in which the URL is used as the address information is described above, an IP address may be used instead, for example.

Steps S812 to S820 are a sequence according to the system of OAuth.

In step S812, the external server A120 receives the HTTP request from the web browser 403. The external server A120 generates a URL string for accessing an authorization page of the external server B130, according to the received HTTP request. Next, the external server A120 generates a HTTP response for redirection to the URL shown by the generated URL string, and sends back the HTTP response to the web browser 403.

In step S813, the web browser 403 transmits another HTTP request to the redirection target URL included in the HTTP response received in step S812. Since the redirection target URL is a URL for accessing the authorization page of the external server B130 as described above, the HTTP request is transmitted to the external server B130.

In step S814, the external server B130 receives the HTTP request for accessing the authorization page, generates a HTTP response showing the authorization page, and sends back the HTTP response to the web browser 403. The web browser 403 displays the authorization page according to the received HTTP response.

In step S815, the web browser 403 transmits information such as a user ID and a password for the external server B130 which is inputted by the user and which is required for the authorization, to the external server B130 as an authorization request.

In step S816, the external server B130 having received the authorization request determines whether to allow the external server A120 to use the functions of the external server B130, on the basis of the received information required for the authorization. Then, in a case where the external server A120 is allowed to use the functions of the external server B130 as a result of the determination in step S816, the external server B130 issues an authorization code. The external server B130 generates a HTTP response including the issued authorization code and the URL for redirection to the external server A120, and sends back the HTTP response to the web browser 403. Here, the URL information for redirection to the external server A120 may be registered in the external server B130 in advance or included in the URL string generated by the external server A120 in step S812.

In step S817, the web browser 403 obtains the URL for redirection and the authorization code which are included in the HTTP response sent back from the external server B130. The web browser 403 transmits a HTTP request including the authorization code to the external server A120 as an authorization token obtaining request, on the basis of the URL obtained in step S817.

In step S818, the external server A120 having received the authorization token obtaining request from the web browser 403 obtains the authorization code included in the request and transmits an authorization token obtaining demand to the external server B130.

In step S819, the external server B130 having received the authorization token obtaining demand verifies the authorization code included in the demand and issues the authorization token if the authorization code is correct. The external server B130 sends back the issued authorization token for the external server A120 as a response to the authorization token obtaining demand.

In step S820, the external server A120 stores the received authorization token as an authorization token used in access to the external server B130, in association with the user (user authenticated in S800, S801) currently accessing the external server A120. The external server A120 accesses the external server B130 by using the stored authorization token in a case where the user accessing the external server A120 accesses the external server B130 from this point and after. Furthermore, the external server A120 sends back a response to the authorization token obtaining request of step S817. This response includes a redirection URL to the application 408.

In step S821, the web browser 403 having received the response of step S820 obtains the redirection URL included in the response, and transmits a HTTP request to the redirection target. The HTTP request transmitted from the web browser 403 in this step is an authorization operation completion request, and the redirection target is set to the application 408. In other words, the application 408 receives the authorization operation completion request from the web browser 403.

In step S822, the application 408 determines that the authorization operation is completed, from the authorization operation completion request received from the web browser 403.

In step S823, the application 408 displays the operation screen of the application 408 itself on the front face of the operation unit 219 (second screen control process).

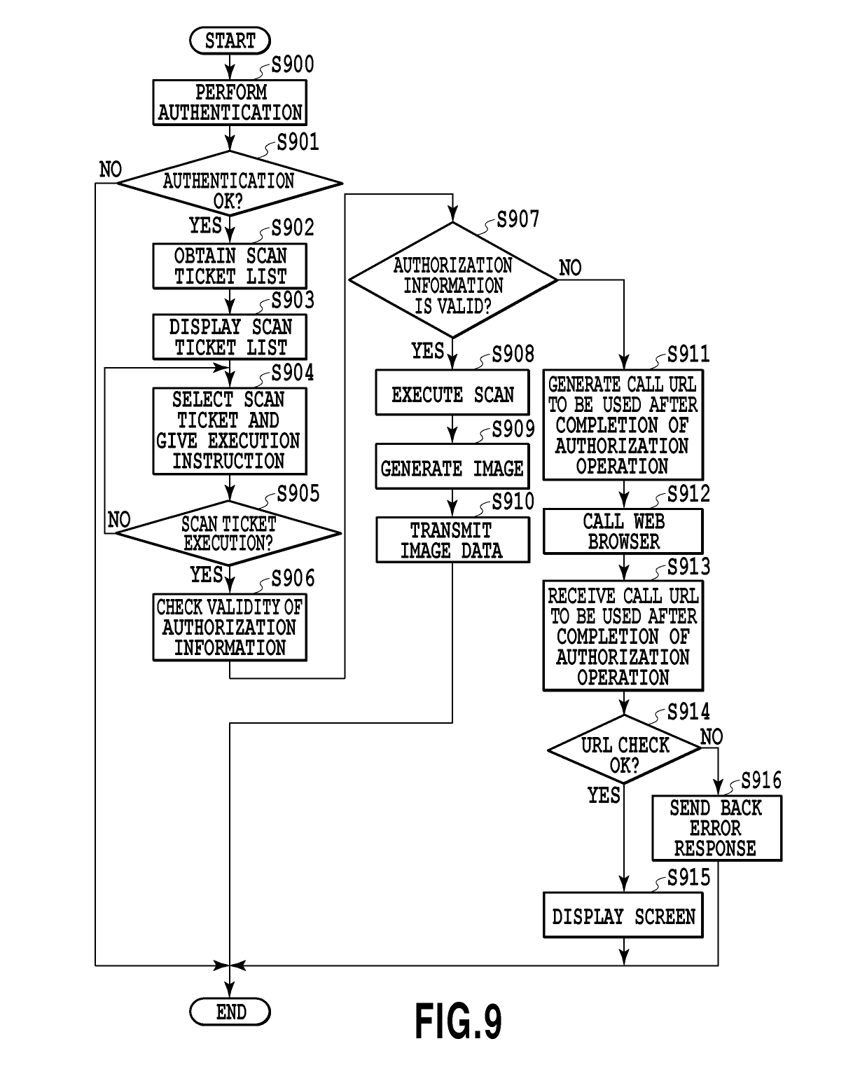

FIG. 9 is a view showing an example of a flowchart of the application 408 in the embodiment. Operations (steps) shown in the flowchart of FIG. 9 are implemented by the CPU 211 of the image processing apparatus 100 executing the control program stored in the HDD 214 or the like.

In step S900, the UI control unit 501 displays a log-in screen for accessing the external server A120, in response to an instruction by the user from the operation unit 219. The log-in screen is assumed to have an input area for the information (user ID, password, and the like) required for the authentication to the external server A120. Next, in response to an input operation on the log-in screen by the user, the UI control unit 501 obtains the information (user ID, password, and the like) required for the authentication to the external server A120. The UI control unit 501 sends the communication unit 504 the obtained information (user ID, password, and the like) required for the authentication to the external server A120. The communication unit 504 includes the information (user ID, password, and the like) required for the authentication to the external server A120 from the UI control unit 501 into an authentication request to the external server A120, and transmits the authentication request to the external server A120.

In step S901, the communication unit 504 receives a reply to the authentication request from the external server A120, and obtains an authentication result included in the reply. In a case where authentication is successful in the authentication result, the processing proceeds to step S902. In a case where the authentication has failed, the communication unit 504 notifies the UI control unit 501 of the authentication result. The UI control unit 501 having received the notification of authentication failure displays an error message and terminates the processing.

In a case where the authentication is successful, in step S902, the communication unit 504 stores session information included in the reply to the authentication request, in the HDD 214 or the RAM 213. Hereafter, the communication unit 504 transmits demands and requests while including the session information stored in the HDD 214 or the RAM 213 into the demands and the request in communication with the external server A120, until a series of processes is completed. Next, the communication unit 504 transmits a ticket obtaining request for requesting a ticket list to the external server A120. Then, the communication unit 504 receives a reply to the ticket obtaining request from the external server A120.

In step S903, the communication unit 504 obtains the ticket list in the reply to the received ticket obtaining request, and transmits ticket list information to the UI control unit 501. The UI control unit 501 having received the ticket list information displays a ticket list display screen like one shown in FIG. 7 on the operation unit 219.

In step S904, the UI control unit 501 waits for the user to perform an operation of giving a ticket execution instruction through the ticket list display screen.

In step S905, the UI control unit 501 determines whether the user has performed an operation of selecting one ticket and giving the ticket execution instruction through the operation unit 219. In a case where the ticket execution instruction is given, the processing proceeds to step S906. In a case where no ticket execution instruction is given, the processing returns to step S904 and the UI control unit 501 waits for the ticket execution instruction.

In step S906, the UI control unit 501 notifies the communication unit 504 of the fact that the ticket execution instruction is given and of the selected ticket information. The communication unit 504 having received the notification transmits an authorization information validity check request including the ticket information to the external server A120. The external server A120 checks whether the external server A120 holds an authorization token for a transmission target included in the received ticket information, and also checks whether the authorization token is valid in a case where the external server A120 holds the authorization token. The external server A120 then sends back the result of the check to the communication unit 504 as a reply. The communication unit 504 receives the reply to the authorization information validity check request from the external server A120.

In step S907, the communication unit 504 obtains the determination result on whether the authorization token for the external server B130 held by the external server A120 is valid or invalid, from the reply to the authorization information validity check request. In a case where the authorization token is valid in the determination result, the processing proceeds to step S908. Ina case where the authorization token is invalid, the processing proceeds to step S911. Note that, in a case where the external server A120 is determined to hold no authorization token, the processing also proceeds to step S911 as in the case where the authorization token is invalid.

The authorization token for the external server B130 which is held by the external server A120 is used in a case where an image file received by the external server A120 is subjected to the image process and transmitted to the external server B130. Moreover, information included in the ticket include an identifier and a ticket name for identifying the ticket, parameters related to the image process in the external server A120, designation of the transmission target (for example, external server B130), and the like.

Since the authorization token is valid, the communication unit 504 determines in step S908 that the application 408 can be executed. In the embodiment, the communication unit 504 determines that the scan process can be executed and requests the scan process control unit 502 to execute scanning. The scan process control unit 502 requests the controller control unit 401 to perform a process in response to the scan execution request from the communication unit 504, and thus executes the scan process.

In step S909, the scan process control unit 502 obtains image data obtained as a result of the scan process, and performs a format conversion process to a file format such as PDF file.

In step S910, the scan process control unit 502 transmits the image file generated in step S909 to the communication unit 504. The communication unit 504 having received the image file transmits the image file to the external server A120, together with the ticket information received in step S906. The external server A120 having received the image file executes the image process according to the ticket information, and transmits the image file obtained as an image process result to the external server B130 by using the authorization token.

Meanwhile, in a case where the authorization token is invalid, in step S911, the communication unit 504 notifies the web browser cooperation unit 505 that the authorization token is invalid. The web browser cooperation unit 505 generates the URL of the application 408 to which the web browser 403 is to transmit a request after the authorization operation is completed.

In step S912, the web browser cooperation unit 505 generates, for the web browser 403, a URL string in which the generated URL of the application 408 is added to the URL of an authorization information obtaining page of the external server A120 as a query string. Next, the web browser cooperation unit 505 transmits the generated URL string to the web browser 403. Here, the web browser cooperation unit 505 obtains the session information stored by the communication unit 504 in step S902 described above, and also transmits the session information to the web browser 403. The web browser 403 is thereby displayed on the front face of the operation unit 219 of the image processing apparatus 100. In this case, the web browser 403 transmits a HTTP request on the basis of the generated URL string, and accesses the authorization information obtaining page of the external server A120. The external server A120 stores the query string of the received HTTP request and uses the query string as a redirection target URL in the process performed upon completion of the authorization operation which is described in S820.

Step S913 is a process performed after the user completes the series of operations performed on the web browser 403 displayed on the operation unit 219 of the image processing apparatus 100 in step S912. In step S913, the communication unit 601 of the web browser 403 transmits the HTTP request to the URL of the application 408 described in steps S911, S912. The HTTP request from the web browser 403 is received by the web browser cooperation unit 505. In the embodiment, the HTTP request includes the URL of the application 408 as the redirection URL included in the response from the external server A120. The communication unit 601 of the web browser 403 can thus transmit the HTTP request to the URL of the application 408.

In step S914, the web browser cooperation unit 505 determines whether the HTTP request from the web browser 403 is a request targeted for the URL generated in step S911 described above. In a case where the HTTP request is a request to the URL generated in step S911 described above, the processing proceeds to step S915. Meanwhile, in a case where the HTTP request is not a request to the URL generated in step S911 described above, the processing proceeds to step S916.

In step S915, the web browser cooperation unit 505 transmits a response of a HTTP status code 200 meaning success as a reply to the HTTP request. Next, the web browser cooperation unit 505 notifies the UI control unit 501 of an operation screen display request. The UI control unit 501 having received the operation screen display request displays the operation screen of the application 408 on the front face of the operation unit 219 of the image processing apparatus 100.

Meanwhile, in step S916, the web browser cooperation unit 505 transmits a response of error status such as a HTTP status code 400 as a reply to the HTTP request.

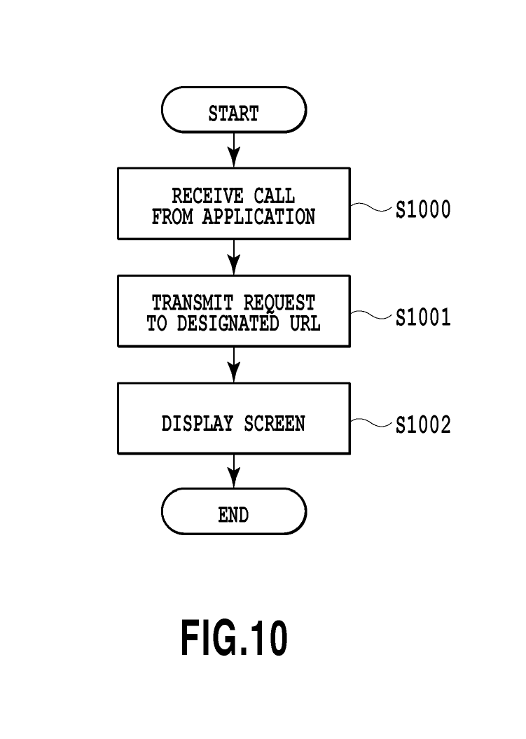

FIG. 10 is a view showing a flowchart of the web browser 403 in the embodiment. Operations (steps) shown in the flowchart of FIG. 10 are implemented by the CPU 211 of the image processing apparatus 100 executing the control program stored in the HDD 214.

In step S1000, the application cooperation unit 604 receives the URL string and the session information which are transmitted from the web browser cooperation unit 505 of the application 408 and which are described in aforementioned step S912.

In step S1001, the application cooperation unit 604 transmits the URL string and the session information received from the web browser cooperation unit 505, to the communication unit 601. The communication unit 601 transmits the HTTP request to the URL shown by the URL string. Here, the transmission target of the HTTP request is set to the external server A120 and the communication unit 601 includes the session information into a Cookie in the generation of the HTTP request. This enables the web browser 403 to take over the communication session between the application 408 and the external server A120, upon communicating with the external server A120. Moreover, the communication unit 601 passes, to the session management unit 603, the session information and information which the web browser 403 has exchanged with the external server A120 in this communication session. The session management unit 603 stores the received session information and the received information which the web browser 403 has exchanged with the external server A120 in this communication session in the RAM 213 or the HDD 214, and manages the received session information and the received information.

In step S1002, the communication unit 601 notifies the UI control unit 602 of the operation screen display request. The UI control unit 602 having received the operation screen display request displays the operation screen of the web browser 403 on the front face of the operation unit 219 of the image processing apparatus 100. Here, a response to the HTTP request transmitted in step S1001 described above is displayed on the displayed screen of the web browser 403. Since the web browser 403 communicates with the external server A120 by taking over the communication session between the external server A120 and the application 408 as described above, no authentication operation from the web browser 403 to the external server A120 is necessary.

As described above, in the first embodiment, the screen control performed between the application 408 and the web browser 403 enables a user to perform a series of operations provided on the operation unit 219 of the image processing apparatus 100. Moreover, the user thus only has to perform the original document read operation once in the assumed use case. Furthermore, in the case where the screen control changes from the application 408 to the web browser 403, no authentication operation to the connection target server (service) is necessary.

In the first embodiment, description is given of the case where the scanning is performed in the image processing apparatus 100. As another embodiment, the present invention can be applied to solve similar problems which occur in communication performed between the image processing apparatus 100 and the external server A120 and between the external server A120 and the external server B130 in the case where printing is to be performed.

### Second Embodiment

A second embodiment provides a system in which information (session information, cache) stored in a web browser 403 is deleted by an authorization operation of a user in a cooperative operation of an application 408 and a web browser 403 of an image processing apparatus 100. This can reduce a security risk of the user such as information leakage in an operation of the web browser 403.

Configurations and the like of the image processing apparatus and external servers in the second embodiment can be basically the same as the configurations described in the first embodiment. Description is given below with a focus on points which are different from the first embodiment.

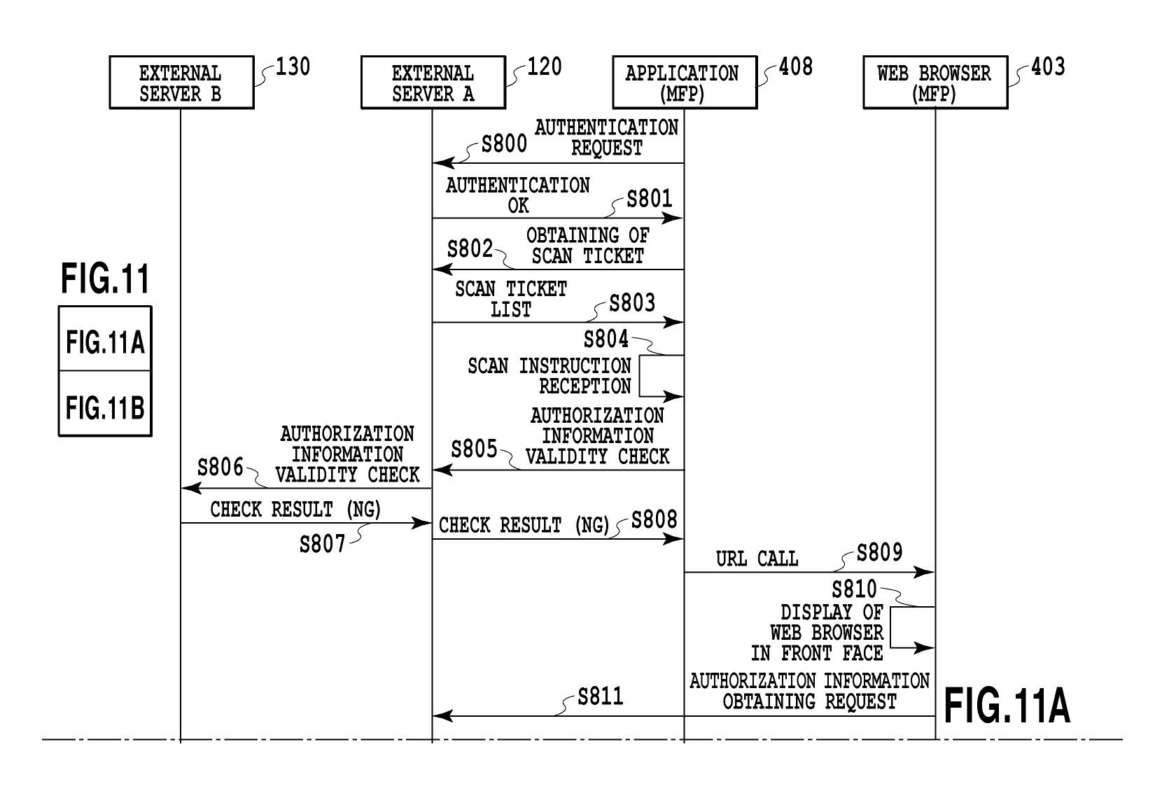

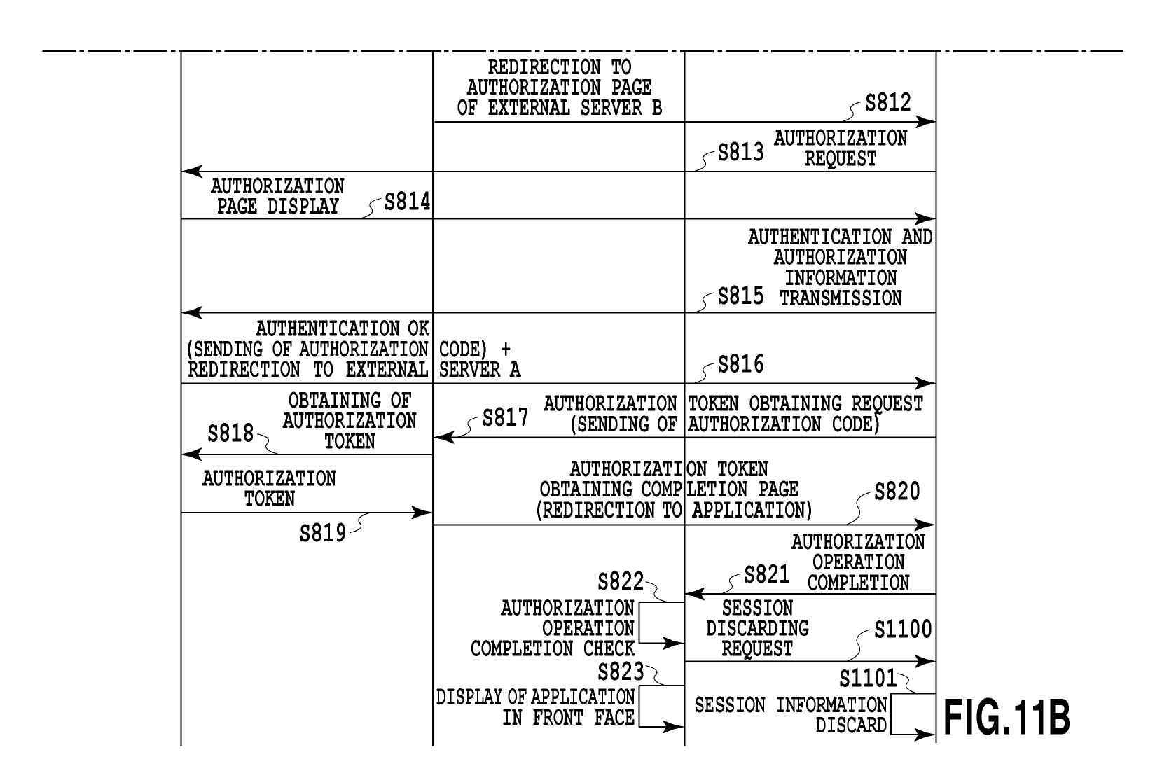

FIG. 11 is a diagram showing a process sequence in the embodiment. Note that, since steps S800 to S823 in FIG. 11 can be the same processes as steps S800 to S823 of FIG. 8 in the first embodiment, description thereof is omitted.

In step S1100, the application 408 having determined that the authorization operation is completed transmits a session discarding request to the web browser 403.

In step S1101, the web browser 403 having received the session discarding request deletes operation history, a cache, and session information from steps S809 to S821. Specifically, the web browser 403 deletes the session information passed from the application 408 in step S809 and the cache of screen information on operations by the user on the web browser 403 in steps S810 to S821.

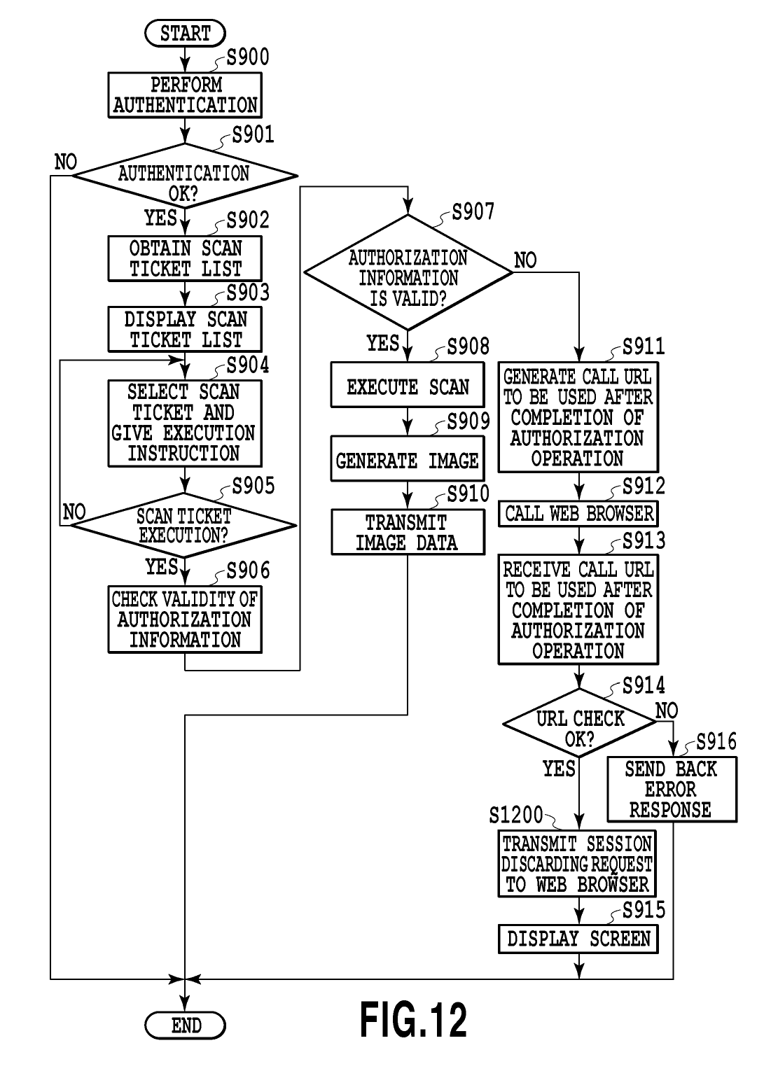

FIG. 12 is a view showing a flowchart of the application 408 in the embodiment. Operations (steps) shown in the flowchart of FIG. 12 are implemented by a CPU 211 of the image processing apparatus 100 executing a control program stored in a HDD 214 or the like.

Note that, since steps S900 to S916 in FIG. 12 can be the same processes as steps S900 to S916 of FIG. 9 in the first embodiment, description thereof is omitted.

In step S1200, a web browser cooperation unit 505 transmits the session discarding request to the web browser 403.

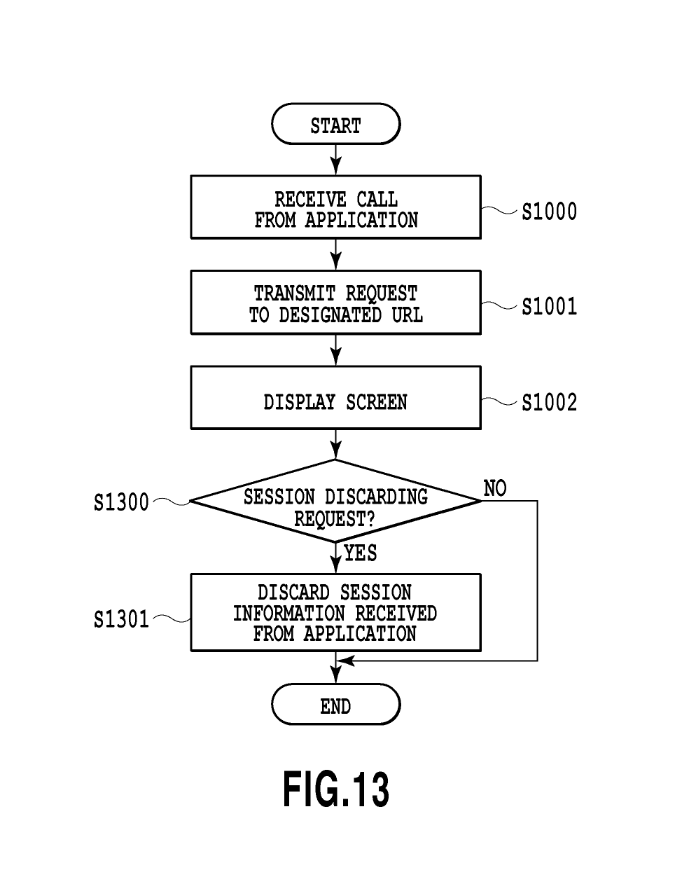

FIG. 13 is a view showing a flowchart of the web browser 403 in the embodiment. Operations (steps) shown in the flowchart of FIG. 13 are implemented by the CPU 211 of the image processing apparatus 100 executing the control program stored in the HDD 214.

Note that, since steps S1000 to S1002 in FIG. 13 can be the same processes as steps S1000 to S1002 of FIG. 10 in the first embodiment, description thereof is omitted.

In step S1300, an application cooperation unit 604 determines whether the session discarding request has been received from the web browser cooperation unit 505 of the application 408. Ina case where the session discarding request has been received, the processing proceeds to step S1301. In a case where the session discarding request has not been received, the processing is terminated.

In step S1301, the application cooperation unit 604 requests a session management unit 603 to discard the session. The session management unit 603 deletes the session information received from a communication unit 601 in step S1001 described above and information exchanged by the web browser 403 with an external server A120 in this communication session, from the RAM 213 or the HDD 214 in which the information is stored.

As described above, in the second embodiment, the screen control performed between the application 408 and the web browser 403 enables a user to perform a series of operations provided on the operation unit 219 of the image processing apparatus 100. Moreover, it is possible to delete the cache and the session information on the operations performed in the change of screen control from the application 408 to the web browser 403. This can reduce the security risk of the user such as information leakage in the operation of the web browser 403.

### OTHER EMBODIMENTS

In the examples described above, description is given of the case where the first server is made to perform a predetermined image process and send the processed data to the second server. However, the present invention may be applied to information processing in which the first server is made to obtain predetermined information from the second server to perform a predetermined information process.

In the examples described above, description is given of the case of cooperation between the application and the web browser on the image processing apparatus. However, as described above, it is possible to employ an embodiment in which the present invention is applied to cooperation between the application and the web browser on an information processing apparatus. Specifically, an information processing apparatus in which the size of an operation screen is restricted and an information processing apparatus which does not support multi-window are assumed to have the same problems as those described above. In such a case, employing the configurations of the embodiments described above enables screen control between an arbitrary application and the web browser.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-270525, filed Dec. 11, 2012, which is hereby incorporated by reference herein in its entirety.

What is claimed is:

1. An information processing apparatus comprising:
a display unit configured to display an operation screen of an application including a process of instructing a first server to perform a process on a second server;
a first screen control unit configured to display a browser on the display unit in a case where authorization information used in the process to be performed by the first server on the second server is invalid, the browser configured to perform an operation of validating the authorization information; and
a second screen control unit configured to display the operation screen of the application on the display unit in a case where the operation of validating the authorization information is completed.

2. The information processing apparatus according to claim 1, further comprising a determination unit configured to determine whether the authorization information used in the process to be performed by the first server on the second server is valid, wherein
the first screen control unit displays the browser configured to perform the operation of validating the authorization information, on the display unit in place of the operation screen of the application in a case where the determination unit determines that authorization information is invalid, and
the second screen control unit displays the operation screen of the application on the display unit in place of the browser in a case where the operation of validating the authorization information is completed.

3. The information processing apparatus according to claim 1, wherein the browser performs the operation of validating the authorization information by using session information between the application and the first server.

4. The information processing apparatus according to claim 3, wherein the browser deletes the session information upon completion of the operation of validating the authorization information.

5. The information processing apparatus according to claim 1, wherein the browser requests the first server to obtain the authorization information from the second server according to address information notified from the application.

6. The information processing apparatus according to claim 5, wherein the address information includes call information to call the application, the call information used upon completion of the operation of validating the authorization information.

7. The information processing apparatus according to claim 1, wherein the application is executed in a first execution environment while the browser is executed in a second execution environment different from the first execution environment.

8. A method of controlling an information processing apparatus including a display unit, the method comprising:
a display step of displaying an operation screen of an application including a process of instructing a first server to perform a process on a second server;
a first screen control step of displaying a browser on the display unit in a case where authorization information used in the process to be performed by the first server on the second server is invalid, the browser configured to perform an operation of validating the authorization information; and
a second screen control step of displaying the operation screen of the application on the display unit in a case where the operation of validating the authorization information is completed.

9. A non-transitory computer readable storage medium storing a program which causes a computer to perform the method according to claim 8.
